(19) United States
(12) Patent Application Publication
(10) Pub. No.: US 2002/0172752 A1
(43) Pub. Date: Nov. 21, 2002

(54) Formed dog chew

(76) Inventor: Jeffrey J. Chizmas, Saugus, MA (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/012,201

(22) Filed: Dec. 4, 2001

Related U.S. Application Data
(60) Provisional application No. 60/251,300, filed on Dec. 5, 2000.

(51) Int. Cl. A23K 1/00

(52) U.S. Cl. 426/623; 426/512

(57) ABSTRACT

A formed dog chew is produced by molding, extrusion or other fabrication technique, and includes, as a forming material, a corn or wheat based polymer, nylon or other non-toxic polymer, whether digestible or undigestible, which has not been shown harmful if ingested by an animal, to which is added any of various additives which impart various benefits purportedly associated with such substances when the dog chew is gnawed by the pet by virtue of release thereof into the dog's mouth as the chew is gradually consumed over time.

### CROSS REFERENCE TO RELATED APPLICATIONS

This application claims the benefit of U.S. Provisional Application No. 60/251,300 filed Dec. 5, 2000 entitled FORMED DOG CHEW.

### BACKGROUND OF THE INVENTION

The present invention relates generally to a formed dog chew, and more particularly, to a formed dog chew which, when used by a dog, provides entertainment, jaw exercise, and potential avoidance of dental and other health problems.

Molded dog chews are known in the art, and are generally provided in a convenient shape to allow gnawing of same by a pet. Most often, a simple dog bone shape is utilized, such that the molded product takes on the appearance of a familiar shape having an elongated configuration with enlarged ends. Many substances have been suggested for use as a composition for creating a formed dog chew, including naturally-based and synthetic polymers. For example, dog chews fashioned in a shape resembling a bone are commercially available which utilize corn-based material and nylon as a forming material. The prior art has also suggested the addition of rawhide and other animal components to the above-mentioned nylon forming material in order to provide organic supplementation.

A method is disclosed in U.S. Pat. No. 5,665,152 issued to Bassi et al., which is directed to manufacture of solid, biodegradable products, consisting primarily of utensils, cups, plates and other convenience products, and which is incorporated herein by reference. In accordance with the method, the various products produced thereby are comprised of a composition derived by processing starting ingredients which include disclosed quantities of grain protein, starch, a plasticizer and a reducing agent. The products produced by the method disclosed in Bassi et al. are produced by injection molding, extrusion or other suitable forming techniques.

Although such articles produced by the method disclosed in the Bassi et al. patent address the need for biodegradable articles which avoid use of synthetic resins, the reference does not intend the use of articles produced by such method to be used for oral consumption, since they are described in the reference as non-edible. Further, since the disclosed subject matter of the above described patent is not directed to products intended for injection, no suggestion to incorporate additives which can potentially impart health benefits to a pet when an article formed of such substance is chewed.

It is therefore an object of the invention to provide a formed dog chew which overcomes the drawbacks of the prior art.

It is a further object of the invention to extend the applicability of articles produced by the method of the above described Bassi et al. reference to specific use as dog chews, and to incorporate therein additives intended to impart health benefits to a pet when such articles are chewed.

It is a still further object of the invention to provide a dog chew formed of composition which includes a wheat or corn based polymer and additives including natural and herbal remedies, vitamins, components for advancing dental health and/or ingredients which are intended for increasing palatability.

Yet a further object of the invention is to provide a dog chew formed in a specific shape designed to elicit animal interest advantageously coupled with a taste corresponding to such shape.

### SUMMARY THE INVENTION

In accordance with these and other objects of the invention, there is provided a formed dog chew (molded, extruded or otherwise fabricated) which is of solid construction, and which is comprised of a corn or wheat based polymer, nylon or other non-toxic polymer, whether digestible or undigestible, which has not been shown harmful if ingested by an animal, to which is added any of a number of additives which impart various benefits purportedly associated with such substances when the dog chew is gnawed by the pet by virtue of release thereof into the dog's mouth as the chew is gradually consumed over time.

### DETAILED DESCRIPTION OF THE PREFERRED EMBODIMENT

In accordance with an embodiment of the invention, a dog chew is formed of a composition comprised of POLYTRITICUM 200 resin, available from Midwest Grain Products, Inc, 1300 Main Street, Atchison, Kans. 66002 (i.e., a composition produced in accordance with the disclosure of U.S. Pat. No. 5,665,152 identified above and incorporated herein by reference) or other suitable non-toxic resin available presently, or developed at a later date, which is supplemented with one or more additives, and as described more fully below. The additives include any substance which have been shown to, or are believed to, impart one or more beneficial characteristics to the formed article.

In accordance with an advantageous embodiment of the above described dog chew, the category of additives are substances which are intended to increase animal appeal and/or palatability. Such substances include, for example, rawhide, pork, beef, fruit lamb, rice, peanut butter and vegetable products. This list is illustrative only, and is not intended to be exhaustive of possible additives suitably included in the article for the above stated purposes.

In accordance with another embodiment of the above described dog chew, the molded or formed articles are fortified or enhanced with substances intended to impart health benefits to a pet as the article is chewed over time. Such additives will include, but not be limited to, nutritional supplements, vitamins, minerals, brewer's yeast, fortification based upon dog's age, and natural or herbal remedies. Such herbal remedies may include, for example, echinacea, shark cartilage, and any other product purported to affect an animal's health, vision, mental state, temperament, agility, stamina, etc. Additives for improving the health of teeth or for improving breath can similarly be added, such as, for example, calgon, mint and chlorophyll.

In accordance with a particularly advantageous embodiment, specific use of wheat gluten based polymer (U.S. Pat. No. 5,665,152 referenced above) is employed, to which is added the herein disclosed substances, which include, for example, rawhide, pork (pig ears, etc.) or other natural substances.

In accordance with the invention the additives, such as those described above will advantageously be present in the composition in an amount not to exceed about 20% by weight of the total mixture. Particle size of the various additives, when present in solid form, will advantageously be as fine as possible for improving homogeneous dispersal of the additive or additives throughout the composition.

In accordance with yet another embodiment of the invention, the hardness of the finished product is optionally modified by adjusting moisture content during forming and/or by the addition of ingestible plasticizers, such as glycerine. These techniques are known to one of ordinary skill in the art, and therefore further disclosure is omitted as unnecessary. The resultant chewable dog article can thereby be tailored to the specific needs of a dog by age of the dog or other factor which might warrant a chew of different hardness.

In accordance with a particularly advantageous embodiment, a dog chew is flavored with an additive, and the chew is then molded in a shape normally associated with the flavor additive. For example, a dog chew in accordance with such embodiment may contain pork as an additive, in which case the finished article will take the shape of a pig hoof or a pig ear. Similarly, products containing rawhide could be fashioned in the shape of chips resembling the shape of dried rawhide. Because products in accordance with the embodiments are molded, the invention provides advantage over natural shapes in that the consistency of shape of each of the articles can be reliably maintained, and can further be engineered to permit nesting of one with the other, thereby minimizing required storage space and reducing shipping costs.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A formed dog chew, comprising:
a solid formed mass including a non-toxic polymer material; and
at least one additive having a characteristic purported to impart health benefits to a pet, whereby said at least one additive is released in gradual amounts orally to the pet as the solid formed mass is chewed over time.

2. A formed dog chew, comprising:
a solid formed mass including a wheat-gluten based polymer material; and
at least one additive for imparting beneficial supplementation to said formed mass.
